(19) United States
(12) Patent Application Publication
(10) Pub. No.: US 2004/0093339 A1
(43) Pub. Date: May 13, 2004

(54) Authentication apparatus and computer-readable storage medium

(75) Inventor: Makoto Mochizuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, kAWASAKI (JP)

(21) Appl. No.: 10/688,912

(22) Filed: Oct. 21, 2003

(30) Foreign Application Priority Data
Oct. 23, 2002 (JP) 2002-308563

(51) Int. Cl. G06F 17/00

(52) U.S. Cl. 707/100

(57) ABSTRACT

An authentication apparatus acquires first feature information, extracts from a database which registers feature information in correspondence with each user a user corresponding to feature information having a degree of matching exceeding a predetermined value with respect to the first feature information, and registers the first feature information in the database together with accessory information related to the feature information.

This application claims the benefit of a Japanese Patent Application No.2002-308563 filed Oct. 23, 2002, in the Japanese Patent Office, the disclosure of which is hereby incorporated by reference.

### BACKGROUND OF THE INVENTION

1. Field of the Invention

The present invention generally relates to authentication apparatuses and computer-readable storage media, and more particularly to an authentication apparatus for making an authentication, that is, personal identification, using feature information such as biometric information, and to a computer-readable storage medium which stores a computer program for causing a computer to carry out such an authentication.

In this specification, the feature information including the biometric information and the like, refers to information which is related to an individual and is usable for the authentication (personal identification) and is readable by an input device. Such feature information includes fingerprint patterns, iris patterns, blood vessel patterns, voice patterns and the like.

2. Description of the Related Art

Authentication apparatuses may be categorized into a first type which carries out a 1:1 authentication, and a second type which carries out a 1:N authentication, where N is an integer greater than or equal to 2.

According to the first system, the feature information of each user is registered in advance in an authentication apparatus in correspondence with personal identification (ID) information which enables identification of the user. When the user inputs the user's ID information to the authentication apparatus, the registered feature information corresponding to this ID information is compared with the feature information of the user that is read, and it is confirmed that the user is the user himself if a degree of matching of the compared feature information exceeds a predetermined level.

The security improves when the predetermined level is set to a high value, but in this case, the probability of not confirming the user even when it is the user himself increases. For example, in a case where information related to the fingerprint pattern is used as the feature information, the fingerprint pattern of the user may be slightly different from the finger print pattern that is registered as the feature information due to injuries to the user's fingers after the feature information registration. In such a case, the degree of matching of the compared feature information decreases even though the user being authenticated is the user himself.

On the other hand, when the predetermined level is set to a low value, the degree of matching of the compared feature information increases even when the user injures his fingers after the feature information registration, for example, but the security deteriorates in this case. This is because the degree of matching of the compared feature information also increases for similar feature information. In other words, if a person acquires the ID information of the user and this person's feature information is similar to the feature information of the user, the feature information of this person that is read may match the feature information of the user even though this person is not the user himself.

According to the second system, the feature information of each user is registered in advance in the authentication apparatus. When the feature information of the user is read, the read feature information is successively compared with each of the registered feature information, and it is confirmed that the user is the user himself if the degree of matching of the compared feature information exceeds a predetermined level. In this case, it is unnecessary to input the ID information. However, as the number of users increases, it takes considerable time to carry out the comparing process. In addition, if the number of similar registered feature information increases, the probability of erroneously identifying the user for another person increases, to thereby deteriorate the security. For this reason, the second system is not very popular in an environment in which the emphasis is put on the security.

In the authentication apparatuses which employ the first system or the second system, it is essential to prevent an illegitimate user (person) from impersonating a legitimate user. Hence, it is desirable to improve the authentication accuracy and to positively prevent a person from being erroneously confirmed as the legitimate user. But in the conventional authentication apparatuses, if the number of kinds of registered feature information is increased to improve the authentication accuracy so as to improve the security, there were problems in that the number of items to be compared increases when carrying out the comparing process, and that the authentication time required to carry out the authentication inevitably increases.

In addition, in the case of the conventional authentication apparatus employing the second system, when the number of users increases and the number of registered feature information increases, there was a problem in that the time required to carry out the comparing process increases even if the number of kinds of feature information is only one. Consequently, there was a problem in that the authentication time required to carry out the authentication inevitably increases.

### SUMMARY OF THE INVENTION

Accordingly, it is a general object of the present invention to provide a novel and useful authentication apparatus and computer-readable storage medium, in which the problems described above are eliminated.

Another and more specific object of the present invention is to provide an authentication apparatus and a computer-readable storage medium, which can improve the authentication accuracy without increasing the authentication time and improve the security, regardless of whether the first system or the second system described above is employed.

Still another object of the present invention is to provide an authentication apparatus comprising an acquiring section to acquire first feature information; an extracting section to extract, from a database which registers feature information in correspondence with each user, a user corresponding to feature information having a degree of matching exceeding a predetermined value with respect to the first feature information; and a registering section to register the first feature information in the database together with accessory information related to the feature information. According to the authentication apparatus of the present invention, it is possible to improve the authentication accuracy without increasing the authentication time and improve the security.

A further object of the present invention is to provide an authentication apparatus comprising an acquiring section to acquire personal identification information and feature information of a user; a obtaining section to read, from a database having registered feature information in correspondence with at least personal identification information, registered feature information and accessory information respectively corresponding to the acquired personal identification information, and to obtain a degree of matching of the acquired feature information and the registered feature information read from the database; and a confirming section to confirm the user identified by the acquired personal identification information if a degree of matching of the registered feature information read from the database and each registered feature information corresponding to personal identification information indicated by the accessory information read from the database is smaller than the degree of matching obtained by the obtaining section. According to the authentication apparatus of the present invention, it is possible to improve the authentication accuracy without increasing the authentication time and improve the security.

Another object of the present invention is to provide an authentication apparatus comprising an acquiring section to acquire first and second feature information of a user; an extracting section to extract, from a database which registers first and second registered feature information together with accessory information related to predetermined users for which a degree of matching of the first registered feature information exceeds a predetermined value, specific accessory information corresponding to the first registered feature information having a degree of matching which is a maximum value with respect to the acquired first feature information; and a confirming section to confirm the user if a degree of matching of the acquired second feature information and the second registered feature information registered in the database in correspondence with the first registered feature information having the degree of matching which is the maximum value is greater than a degree of matching of the acquired second feature information and the second registered feature information corresponding to the specific accessory information. According to the authentication apparatus of the present invention, it is possible to improve the authentication accuracy without increasing the authentication time and improve the security.

Still another object of the present invention is to provide a computer-readable storage medium which stores a computer program for causing a computer to carry out an authentication process, the computer program comprising an acquiring procedure causing the computer to acquire first feature information; an extracting procedure causing the computer to extract, from a database which registers feature information in correspondence with each user, a user corresponding to feature information having a degree of matching exceeding a predetermined value with respect to the first feature information; and a registering procedure causing the computer to register the first feature information in the database together with accessory information related to the feature information. According to the computer-readable storage medium of the present invention, it is possible to improve the authentication accuracy without increasing the authentication time and improve the security.

A further object of the present invention is to provide a computer-readable storage medium which stores a computer program for causing a computer to carry out an authentication process, the computer program comprising an acquiring procedure causing the computer to acquire personal identification information and feature information of a user; a obtaining procedure causing the computer to read, from a database having registered feature information in correspondence with at least personal identification information, registered feature information and accessory information respectively corresponding to the acquired personal identification information, and to obtain a degree of matching of the acquired feature information and the registered feature information read from the database; and a confirming procedure causing the computer to confirm the user identified by the acquired personal identification information if a degree of matching of the registered feature information read from the database and each registered feature information corresponding to personal identification information indicated by the accessory information read from the database is smaller than the degree of matching obtained by the obtaining section. According to the computer-readable storage medium of the present invention, it is possible to improve the authentication accuracy without increasing the authentication time and improve the security.

Another object of the present invention is to provide a computer-readable storage medium which stores a computer program for causing a computer to carry out an authentication process, the computer program comprising an acquiring procedure causing the computer to acquire first and second feature information of a user; an extracting procedure causing the computer to extract, from a database which registers first and second registered feature information together with accessory information related to predetermined users for which a degree of matching of the first registered feature information exceeds a predetermined value, specific accessory information corresponding to the first registered feature information having a degree of matching which is a maximum value with respect to the acquired first feature information; and a confirming procedure causing the computer to confirm the user if a degree of matching of the acquired second feature information and the second registered feature information registered in the database in correspondence with the first registered feature information having the degree of matching which is the maximum value is greater than a degree of matching of the acquired second feature information and the second registered feature information corresponding to the specific accessory information. According to the computer-readable storage medium of the present invention, it is possible to improve the authentication accuracy without increasing the authentication time and improve the security.

Other objects and further features of the present invention will be apparent from the following detailed description when read in conjunction with the accompanying drawings.

### BRIEF DESCRIPTION OF THE DRAWINGS

FIG. 1 is a system block diagram showing a first embodiment of an authentication apparatus according to the present invention;

FIG. 2 is a diagram showing computer-readable storage media capable of supplying computer programs and data to the authentication apparatus shown in FIG. 1;

FIG. 3 is a flow chart for explaining a registration operation of the authentication apparatus;

FIG. 4 is a flow chart for explaining an authentication operation of the authentication apparatus employing the first system;

FIG. 5 is a flow chart for explaining an authentication operation of the authentication apparatus employing the second system;

FIG. 6 is a flow chart for explaining a registration monitoring process of the authentication apparatus; and

FIG. 7 is a system block diagram showing a second embodiment of the authentication apparatus according to the present invention.

### DESCRIPTION OF THE PREFERRED EMBODIMENTS

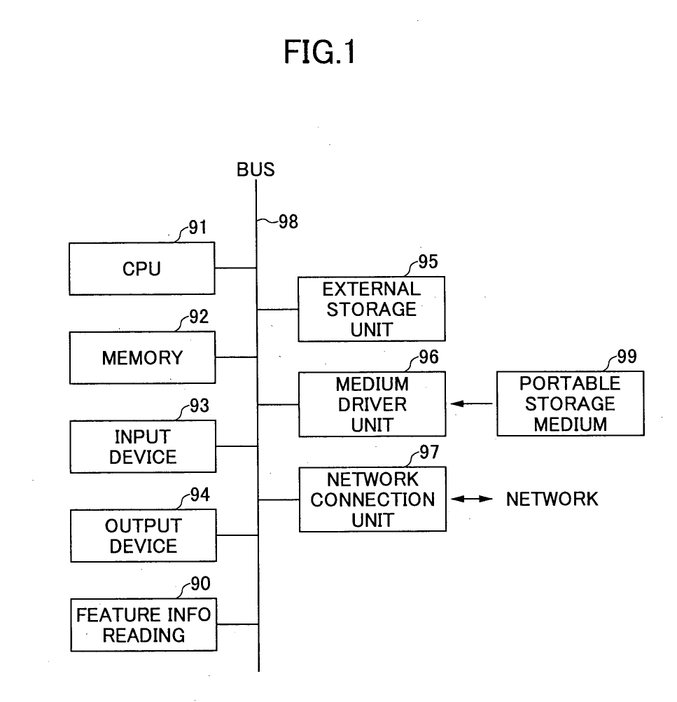

First, a description will be given of a first embodiment of an authentication apparatus according to the present invention, by referring to FIG. 1. FIG. 1 is a system block diagram showing this first embodiment of the authentication apparatus. In this first embodiment of the authentication apparatus, the present invention is applied to a system made up of a single terminal equipment, that is, computer.

The authentication apparatus shown in FIG. 1 includes a feature information reading section 90, a central processing unit (CPU) 91, a memory 92, an input device 93, an output device 94, an external storage unit 95, a medium driver unit 96, and a network connection unit 97 which are mutually connected via a bus 98. A portion including the CPU 91, the memory 92, the input device 93, the output device 94, the medium driver unit 96 and the network connection unit 97 may be realized by a general-purpose computer such as a personal computer. In other words, the authentication apparatus may be formed by the computer.

The feature reading section 90 has a structure for reading feature information of the user by a known method. In this embodiment, it is assumed for the sake of convenience that the feature information reading section 90 is capable of reading 2 kinds of feature information. The 2 kinds of feature information may be selected from a group of feature information including fingerprint patterns, iris patterns, blood vessel patterns, voice patterns and the like.

The memory 92 includes a ROM, a RAM and the like, for example. The memory 92 stores computer programs which are used for processes, and data. The computer programs include a computer program for causing the computer (CPU 91) to function as the authentication apparatus according to the present invention. The CPU 91 carries out necessary processes by executing the computer programs using the memory 92.

The input device 93 is used by the operator (user) to input instructions and information. The input device 93 includes a keyboard, a pointing device, a touch panel and the like, for example. The output device 94 is used to output inquiries to the user and results of the processes. The output device 94 includes a display, a printer, a speaker and the like, for example.

The external storage unit 95 is formed by a magnetic disk unit, an optical disk unit, a magneto-optical disk unit, a tape unit or the like. The authentication apparatus stores the computer programs and the data in the external storage unit 95, and uses the computer programs and the data when necessary by loading the transferring the computer programs and the data to the memory 92.

The medium driver unit 96 drives a portable storage medium 99 and accesses stored contents of the portable storage medium 99. The portable storage medium 99 may be formed by an arbitrary computer-readable storage medium such as a memory card, a floppy disk, a CD-ROM, an optical disk and a magneto-optical disk. The computer programs and the data are stored in the portable storage medium 99, and the user uses the computer programs and the data when necessary by loading and transferring the computer programs and the data to the memory 92.

The network connection unit 97 is connected to an arbitrary communication network (not shown) such as a local area network (LAN) and the Internet, and carries out a data conversion in conformance with the communication format used. The authentication apparatus may receive the computer programs and the data from another apparatus via the network connection unit 97, and use the computer programs and the data when necessary by loading and transferring the computer programs and the data to the memory 92.

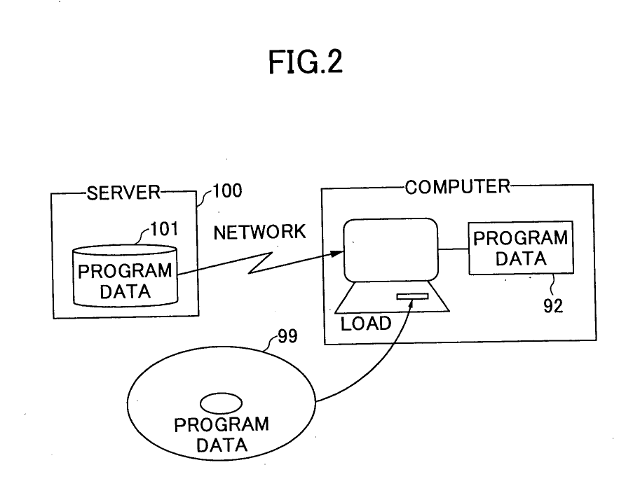

FIG. 2 is a diagram showing the computer-readable storage media capable of supplying the computer programs and the data to the authentication apparatus shown in FIG. 1. The computer programs and the data stored in the portable storage medium 99 and a database 101 of a server 100 are loaded and transferred to the memory 92. In this state, the server 100 generates a carrier signal for carrying the computer programs and the data, and sends the computer programs and the data by the carrier signal to the authentication apparatus via an arbitrary transmission medium of the network. The CPU 91 uses the data to execute the computer programs, to carry out the necessary processes.

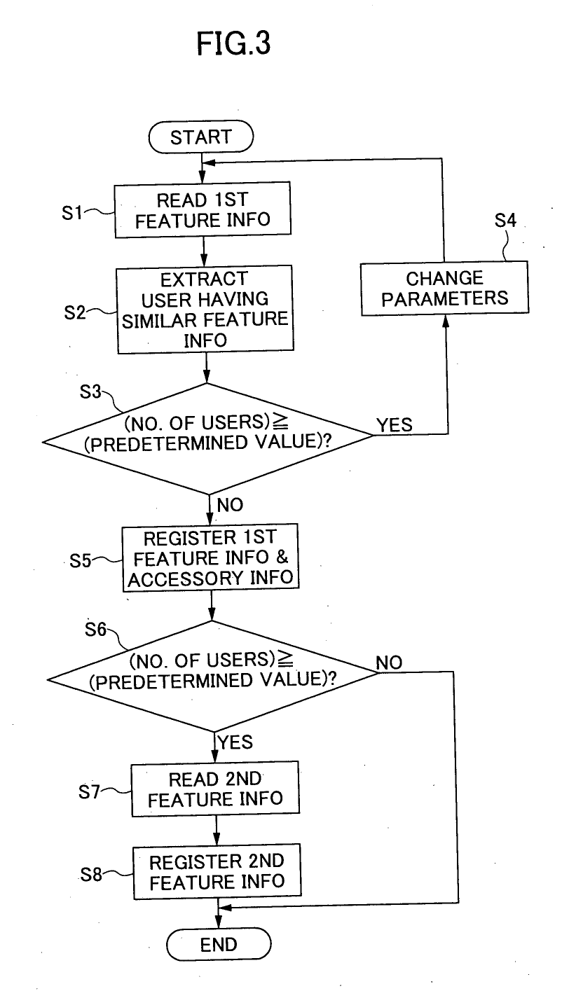

FIG. 3 is a flow chart for explaining a registration operation of the authentication apparatus. The process shown in FIG. 3 is carried out by the CPU 91 shown in FIG. 1 which executes the computer program stored in a first embodiment of a computer-readable storage medium according to the present invention. In this embodiment, it is assumed for the sake of convenience that a database which registers the feature information in correspondence with each user is provided within an appropriate storage of the authentication apparatus, such as the external storage unit 95. However, the database may of course be provided externally to the authentication apparatus, and be a part of the server 100, for example.

In FIG. 3, in a step S1, CPU 91 urges the user to input (read) first feature information by displaying a message on the output device 94, for example. When the first feature information (for example, fingerprint pattern) of the user is read by the feature reading section 90 and parameters are input, the first feature information and the parameters are input to the CPU 91. In a step S2, the CPU 91 accesses the database, and extracts users having registered feature information which is similar to the input first feature information (hereinafter simply referred to as similar registered feature information). The similar registered feature information has a degree of matching exceeding a predetermined level with respect to the input first feature information. In a step S3, the CPU 91 decides whether or not the number of users having the similar registered feature information is greater than or equal to a predetermined value. If the decision result in the step S3 is YES, a step S4 displays a message on the output device 94, for example, to urge the use to change the parameters and re-read the first feature information, and the process returns to the step S1. Hence, the first feature information which is re-read is input to the CPU 91 from the feature reading section 90.

The parameters indicate the conditions under which the feature information is read, that is, the feature information reading conditions. For example, in a case where the fingerprint pattern is to be read as the feature information, the parameters indicate the fingers to which the fingerprint patterns belong. Accordingly, if the fingerprint pattern of the right thumb is read first as the feature information, the parameters may be changed when re-reading the feature information, so as to read the fingerprint pattern of the right middle finger or the left thumb, for example. The parameters may indicate the resolution at which the feature information is to be read.

If the decision result in the step S3 is NO, the CPU 91 registers the read first feature information of the user in the database together with accessory information related to users having similar registered feature information, in a step S5. In a step S6, the CPU 91 decides whether or not the number of users having the similar registered feature information is greater than or equal to a predetermined value. The process ends if the decision result in the step S6 is NO. The predetermined value used in the step S6 does not need to be the same as the predetermined value used in the step S3, and for example, the predetermined value used in the step S6 may be greater than the predetermined value used in the step S3.

If the decision result in the step S6 is YES, the CPU 91 displays a message on the output device 94, for example, so as to urge the user to input (read) second feature information, in a step S7. When the second feature information (for example, iris pattern) of the user is read by the feature reading section 90 and the parameters are input, the second feature information and the parameters are input to the CPU 91. In a step S8, the CPU 91 registers the read second feature information in the database, together with the first feature information of this user which is stored in the database together with the accessory information, and the process ends.

The first feature information and the second feature information may be the same kind of feature information or, may be mutually different kinds of feature information. In the former case, the first feature information is the fingerprint pattern of the right thumb, for example, and the second feature information is the fingerprint pattern of the right third finger, for example. In this former case, the structure of the feature information reading section 90 becomes simple. On the other hand, in the latter case, the first feature information may be the fingerprint pattern of the right thumb, and the second feature information may be the right eye iris pattern, for example. In this latter case, the feature information reading section 90 must be constructed to read both the fingerprint pattern and the iris pattern, but the reliability of the authentication greatly improves because the authentication process is carried out using different kinds of feature information.

Next, a description will be given of the format of information registered in the database by the registration operation shown in FIG. 3, by referring to Tables 1 and 2.

The table 1 shows the registered information within the database when this first embodiment is applied to the first system for carrying out the 1:1 authentication. In this case, it is of course necessary to provide before the step S1 shown in FIG. 3, a step which urges the user to input the user's personal identification (ID) information, and a step which advances the process to the step S1 only when the input ID information is registered in the database. In the Table 1, “INFO” indicates information.

TABLE 1

| | 1ST | | 2ND |
|---|---|---|---|
| | FEATURE | | FEATURE |
| ID INFO | INFO | ACCESSORY INFO | INFO |
| ID001 | F101 | ID101, ID200 | F201 |
| ID002 | F102 | ID301, ID503, ID504 | F202 |
| . | . | . | . |
| . | . | . | . |
| . | . | . | . |
| IDXXX | FYYY | ID101, ID306 | FZZZ |

For example, if the ID information of the user is ID001 and this ID information ID001 is registered in the database and confirmed, the number and the users having the registered first feature information similar to the first feature information F101 are extracted by searching the column of the first feature information in the Table 1. The ID information ID101 and ID200 of the extracted users is registered in the column of the accessory information with respect to the ID information ID001. In addition, if the second feature information F201 of the user having the ID information ID001 is input, this second feature information F201 is registered in the column of the second feature information with respect to the ID information ID001. In the case of the first system, the input feature information is only compared with the registered feature information with respect to the same ID information. Hence, it is essential that the ID information (column of the ID information) is registered in the database.

The table 2 shows the registered information within the database when this first embodiment is applied to the second system for carrying out the 1:N authentication, where N is an integer greater than or equal to 2. In the Table 2, “INFO” indicates information.

TABLE 2

| 1ST | | 2ND | |
|---|---|---|---|
| FEATURE | | FEATURE | |
| INFO | ACCESSORY INFO | INFO | ID INFO |
| F101 | ID101, ID200 | F201 | ID001 |
| F102 | ID301, ID503, ID504 | F202 | ID002 |
| . | . | . | . |
| . | . | . | . |
| . | . | . | . |
| FYYY | ID101, ID306 | FZZZ | IDXXX |

For example, if the first feature information F101 of the user having the ID information ID001 is input, the number and the users having the registered first feature information similar to the first feature information F101 are extracted by searching the column of the first feature information in the Table 2. The ID information ID101 and ID200 of the extracted users is registered in the column of the accessory information with respect to the ID information ID001. In addition, if the second feature information F201 of the user having the ID information ID001 is input, this second feature information F201 is registered in the column of the second feature information with respect to the ID information ID001. In the case of the second system, the input feature information is compared with all of the registered feature information. Hence, it is not essential that the ID information (column of the ID information) is registered in the database. But in order to enable recognition of the ID information which is input as a result of the comparison, it is desirable for the ID information (column of the ID information) to be registered in the database.

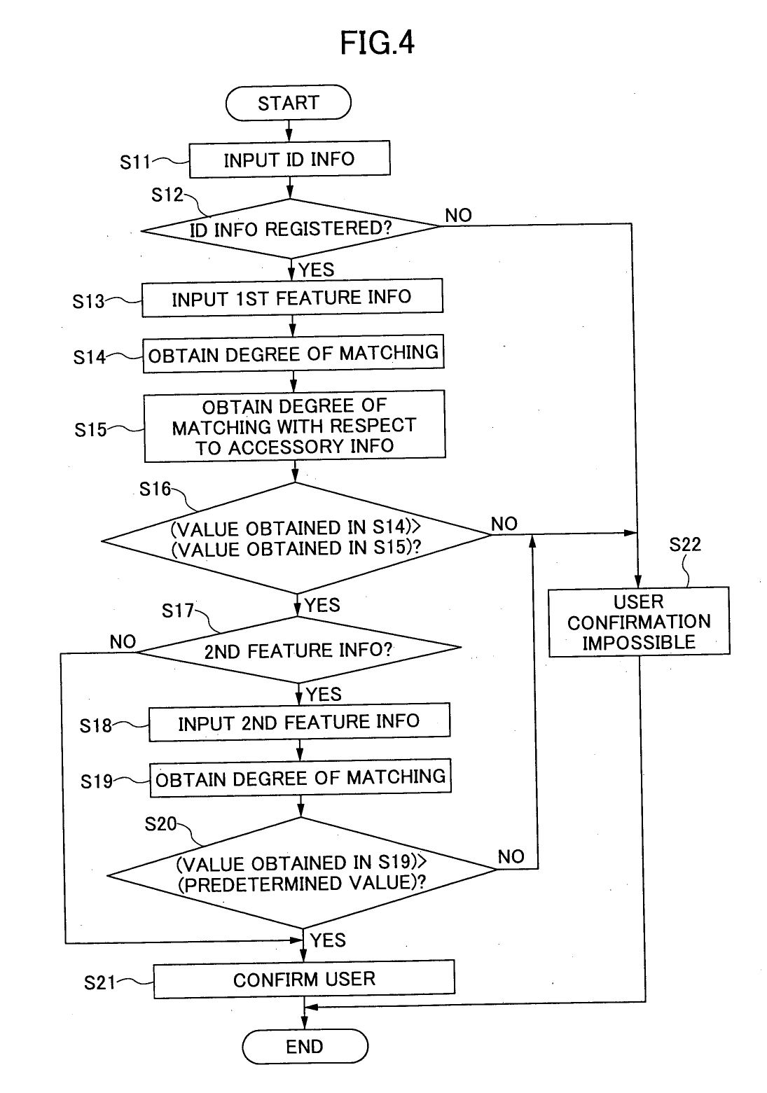

FIG. 4 is a flow chart for explaining an authentication operation of the authentication apparatus employing the first system. The process shown in FIG. 4 is carried out by the CPU 91 shown in FIG. 1 by executing a computer program stored in a second embodiment of the computer-readable storage medium according to the present invention.

In FIG. 4, in a step S11, the CPU 91 displays a message on the output device 94, for example, so as to urge the user to input the ID information, and acquires the ID information input from the input device 93. In a step S12, the CPU 91 decides whether or not the acquired ID information is registered in the database which stores the information shown in the Table 1, for example. If the decision result in the step S12 is NO, a step S22 judges that the user confirmation cannot be made, displays on the output device 94 a message indicating that the user confirmation cannot be made if necessary, and the process ends.

If the decision result in the step S12 is YES, the CPU 91 displays a message on the output device 94, for example, so as to urge the user to input (read) the first feature information, in a step S13. When the first feature information (for example, fingerprint pattern) of the user is read by the feature reading section 90, the read first feature information is input to the CPU 91. In a step S14, the CPU 91 obtains a value indicating the degree of matching of the input first feature information and the first feature information registered in the database in correspondence with the input ID information. In a step S15, the CPU 91 obtains a value indicating the degree of matching of the input first feature information and the first feature information registered in the database in correspondence with the ID information indicated by accessory information corresponding to the ID information. In a step S16, the CPU 91 decides whether or not the value obtained in the step S14 is greater than the value obtained in the step S15. If the decision result in the step S16 is NO, there is a possibility that an illegitimate user (person) is impersonating (pretending to be) the user himself, and the process thus advances to the step S22.

On the other hand, if the decision result in the step S16 is YES, the CPU 91 decides whether or not the second feature information is registered in the database, in a step S17. If the decision result in the step S17 is NO, the process advances to a step S21 which will be described later. If the decision result in the step S17 is YES, the CPU 91 displays a message on the output device 94, for example, so as to urge the user to input (read) the second feature information, in a step S18. When the second feature information (for example, iris pattern) of the user is read by the feature reading section 90, the read second feature information is input to the CPU 91. In a step S19, the CPU 91 obtains a value indicating the degree of matching of the input second feature information and the second feature information registered in the database in correspondence with the input ID information. In a step S20, the CPU 91 decides whether or not the value obtained in the step S19 is greater than a predetermined value which is set in advance. If the decision result in the step S20 is NO, there is a possibility that an illegitimate user (person) is impersonating (pretending to be) the user himself, and the process thus advances to the step S22.

If the decision result in the step S20 is YES, the CPU 91 confirms that the user is the user himself registered in the database, in a step S21. The step S21 displays a message on the output device 94 indicating that the user has been confirmed, if necessary, and the process ends. Hence, it is possible to improve the reliability of the authentication without increasing the authentication time.

The confirmation result obtained by the step S21 is used depending on a system to which the authentication apparatus is applied. For example, when the authentication apparatus is applied to a system which permits or prohibits entry to a research laboratory, a key of the research laboratory is opened in response to the confirmation result obtained by the step S21, so as to permit the user to enter the research laboratory. On the other hand, if the step S22 is carried out, the key of the research laboratory remains locked, to thereby prohibit entry to the research laboratory. The system itself to which the authentication apparatus is applied is not limited to a particular system, and for example, the authentication apparatus is applicable to a system which permits prohibits access to a computer system or a particular storage unit.

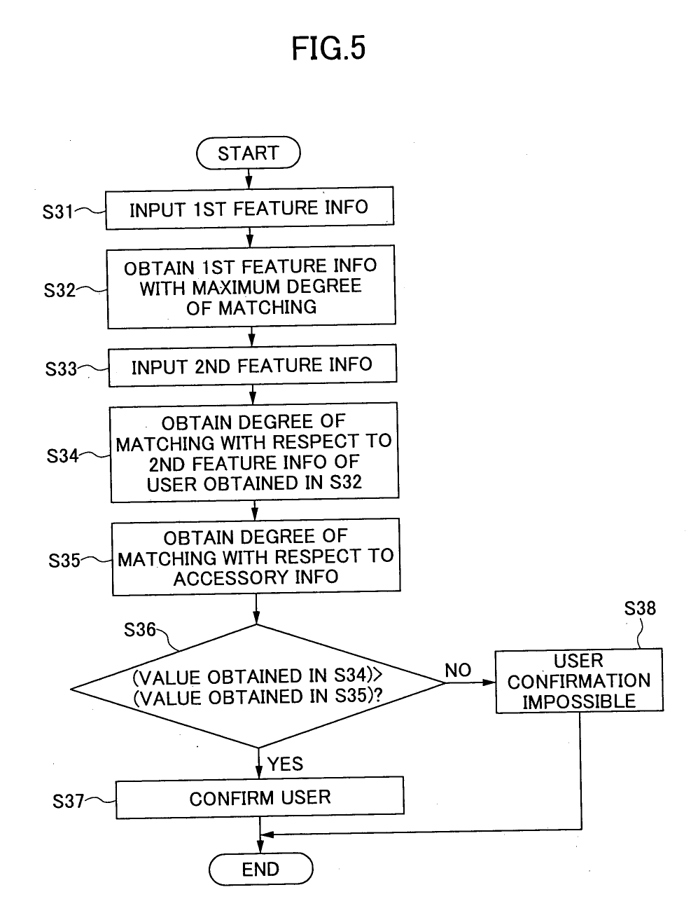

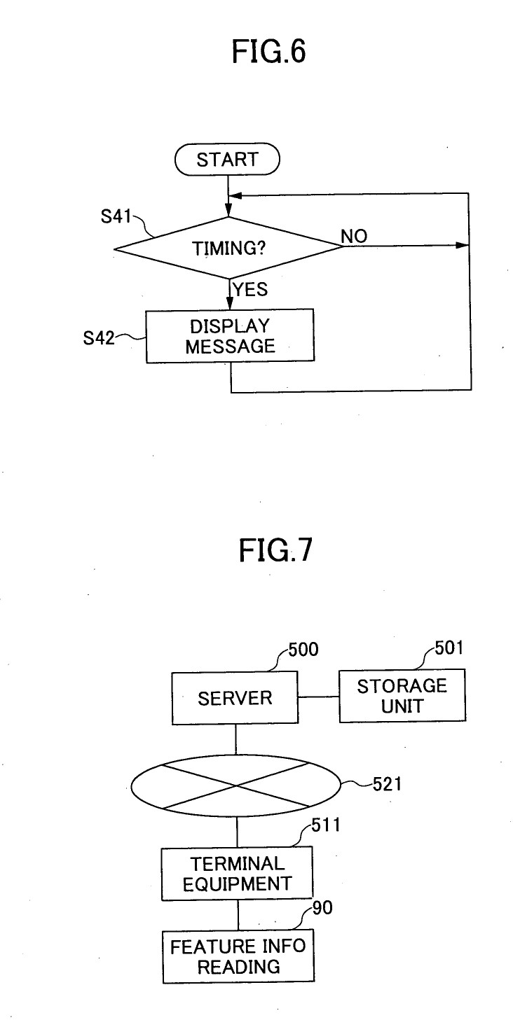

FIG. 5 is a flow chart for explaining an authentication operation of the authentication apparatus employing the second system. The process shown in FIG. 6 is carried out by the CPU 91 shown in FIG. 1 which executes the computer program stored in a third embodiment of the computer-readable storage medium according to the present invention.

In a step S31 shown in FIG. 5, the CPU 91 displays a message on the output device 94, for example, so as to urge the user to input (read) the first feature information. When the first feature information (for example, fingerprint pattern) of the user is read by the feature reading section 90, the read first feature information is input to the CPU 91. In a step S32, the CPU 91 obtains one of the first feature information registered in the database which stores the information shown in the Table 2, for example, having a degree of matching with respect to the input (read) first feature information indicated by a value having a maximum value. In addition, in a step S33, the CPU 91 displays a message on the output device 94, for example, so as to urge the user to input (read) the second feature information. When the second feature information (for example, iris pattern) is read by the feature reading section 90, the read second feature information is input to the CPU 91. In a step S34, the CPU 91 obtains a value indicating a degree of matching of the input (read) second feature information and the second feature information which is registered in the database together with the first feature information obtained by the step S32 and having the degree of matching with respect to the input (read) first feature information indicated by the value having the maximum value. In a step S35, the CPU 91 obtains a value indicating a degree of matching of the input (read) second feature information and the second feature information which is registered in the database in correspondence with the ID information indicated by the accessory information corresponding to the first feature information obtained by the step S32 and having the degree of matching with respect to the input (read) first feature information indicated by the value having the maximum value.

In a step S36, the CPU 91 decides whether or not the value obtained by the step S34 is greater than the value obtained by the step S35. If the decision result in the step S36 is NO, there is a possibility that an illegitimate user (person) is impersonating (pretending to be) the user himself, and the process thus advances to a step S38. The step S38 judges the user confirmation cannot be made, displays on the output device 94 a message indicating that the user confirmation cannot be made if necessary, and the process ends.

On the other hand, if the decision result in the step S36 is YES, the CPU 91 confirms that the user is the user himself registered in the database, in a step S37. The step S37 displays a message on the output device 94 indicating that the user has been confirmed, if necessary, and the process ends. The input (read) second feature information is compared only with the second feature information corresponding to the ID information indicated by the accessory information, and not with all of the second feature information registered in the database. Hence, it is possible to improve the reliability of the authentication without increasing the authentication time.

As described above, the confirmation result obtained by the step S36 is used depending on the system to which the authentication apparatus is applied.

FIG. 6 is a flow chart for explaining a registration monitoring process of the authentication apparatus. The process shown in FIG. 6 is carried out by the CPU 91 shown in FIG. 1 by executing a computer program stored in a fourth embodiment of the computer-readable storage medium according to the present invention.

In a step S41 shown in FIG. 6, the CPU 91 decides whether or not the present timing is a predetermined timing at which the user is to be urged to make a registration process. For example, the predetermined timing may be constant time intervals, a time when a predetermined number of feature information similar to the first feature information registered by the user (that is, feature information with respect to a predetermined number of users (ID information)) is registered in the database, or the like. When the decision result in the step S41 becomes YES, the CPU 91 displays a message on the output device 94, for example, so as to urge the user to make the registration process described above in conjunction with FIG. 3, in a step S42. The process returns to the step S41 after the step S42. In this case, the user who is urged to make the registration process may start the registration process shown in FIG. 3 from the step S7.

By carrying out the registration monitoring process described above, it is possible to urge even the user who has already registered the feature information in the database to add a minimum number of feature information to be registered, so as to prevent the reliability of the authentication from deteriorating due to the increasing number of similar feature information registered in the database. Moreover, the user does not need to be aware of the similar feature information registered in the database.

Next, a description will be given of a second embodiment of the authentication apparatus according to the present invention, by referring to FIG. 7. FIG. 7 is a system block diagram showing this second embodiment of the authentication apparatus. In this second embodiment of the authentication apparatus, the present invention is applied to a system, such as a client-server system, in which a server and at least one terminal equipment (computer) is connected via a network. The authentication apparatus is formed by the server.

In FIG. 7, a server 500 and a terminal equipment 511 are connected via a network 521. A storage unit 501 which forms the database is connected to the server 500. Of course, the storage unit 501 may be connected to the server 500 via the network 521. The feature information reading section 90 is connected to the terminal equipment 511. The network 521 is formed by a cable network and/or a wireless network. Each of the server 500 and the terminal equipment 511 may be formed by a known general purpose computer.

In this second embodiment of the authentication apparatus, the processes described above in conjunction with FIGS. 3 through 6 are carried out by the server 500. The server 500 acquires the feature information which is read by the feature information reading section 90, via the network 521, and sends messages to the terminal equipment 511, via the network 521, unlike the first embodiment of the authentication apparatus described above.

In each of the embodiments described above, the database registers the first feature information and the second feature information. However, the database may of course register first through Mth feature information, where M is an integer greater than or equal to 3. The reliability of the authentication improves as the value of M becomes later, but the authentication time also increases. For this reason, the value of M is desirably set to an appropriate value depending on the reliability of the authentication and the authentication speed that are desired.

Further, the present invention is not limited to these embodiments, but various variations and modifications may be made without departing from the scope of the present invention.

What is claimed is:

1. An authentication apparatus comprising:
an acquiring section to acquire first feature information;
an extracting section to extract, from a database which registers feature information in correspondence with each user, a user corresponding to feature information having a degree of matching exceeding a predetermined value with respect to the first feature information; and
a registering section to register the first feature information in the database together with accessory information related to said feature information.

2. The authentication apparatus as claimed in claim 1, further comprising:
a control section to output a message urging changing of parameters indicating feature information reading conditions and re-reading of the first feature information if a number of the feature information having the degree of matching exceeding the predetermined value exceeds a specific value, so as to acquire the re-read first feature information by said acquiring section.

3. The authentication apparatus as claimed in claim 1, further comprising:
a control section to urge the user to read second feature information and acquire the read second feature information by said acquiring section if a number of the feature information having the degree of matching exceeding the predetermined value exceeds a specific value.

4. The authentication apparatus as claimed in claim 3, wherein said registering section registers the second feature information in the database.

5. The authentication apparatus as claimed in claim 3, wherein the first feature information and the second feature information are the sake kind of feature information or mutually different kinds of feature information.

6. An authentication apparatus comprising:
an acquiring section to acquire personal identification information and feature information of a user;
a obtaining section to read, from a database having registered feature information in correspondence with at least personal identification information, registered feature information and accessory information respectively corresponding to the acquired personal identification information, and to obtain a degree of matching of the acquired feature information and the registered feature information read from the database; and
a confirming section to confirm the user identified by the acquired personal identification information if a degree of matching of the registered feature information read from the database and each registered feature information corresponding to personal identification information indicated by the accessory information read from the database is smaller than the degree of matching obtained by said obtaining section.

7. An authentication apparatus comprising:
an acquiring section to acquire first and second feature information of a user;
an extracting section to extract, from a database which registers first and second registered feature information together with accessory information related to predetermined users for which a degree of matching of the first registered feature information exceeds a predetermined value, specific accessory information corresponding to the first registered feature information having a degree of matching which is a maximum value with respect to the acquired first feature information; and
a confirming section to confirm the user if a degree of matching of the acquired second feature information and the second registered feature information registered in the database in correspondence with the first registered feature information having the degree of matching which is the maximum value is greater than a degree of matching of the acquired second feature information and the second registered feature information corresponding to the specific accessory information.

8. The authentication apparatus as claimed in claim 7, wherein the first feature information and the second feature information are the same kind of feature information or mutually different kinds of feature information.

9. A computer-readable storage medium which stores a computer program for causing a computer to carry out an authentication process, said computer program comprising:
an acquiring procedure causing the computer to acquire first feature information;
an extracting procedure causing the computer to extract, from a database which registers feature information in correspondence with each user, a user corresponding to feature information having a degree of matching exceeding a predetermined value with respect to the first feature information; and
a registering procedure causing the computer to register the first feature information in the database together with accessory information related to said feature information.

10. The computer-readable storage medium as claimed in claim 9, wherein the computer program further comprises:
a control procedure causing the computer to output a message urging changing of parameters indicating feature information reading conditions and re-reading of the first feature information if a number of the feature information having the degree of matching exceeding the predetermined value exceeds a specific value, so as to acquire the re-read first feature information by said acquiring section.

11. The computer-readable storage medium as claimed in claim 9, wherein the computer program further comprises:
a control procedure causing the computer to urge the user to read second feature information and acquire the read second feature information by said acquiring section if a number of the feature information having the degree of matching exceeding the predetermined value exceeds a specific value.

12. The computer-readable storage medium as claimed in claim 11, wherein said registering procedure causes the computer to register the second feature information in the database.

13. The computer-readable storage medium as claimed in claim 11, wherein the first feature information and the second feature information are the sake kind of feature information or mutually different kinds of feature information.

14. A computer-readable storage medium which stores a computer program for causing a computer to carry out an authentication process, said computer program comprising:
an acquiring procedure causing the computer to acquire personal identification information and feature information of a user;
a obtaining procedure causing the computer to read, from a database having registered feature information in correspondence with at least personal identification information, registered feature information and accessory information respectively corresponding to the acquired personal identification information, and to obtain a degree of matching of the acquired feature information and the registered feature information read from the database; and
a confirming procedure causing the computer to confirm the user identified by the acquired personal identification information if a degree of matching of the registered feature information read from the database and each registered feature information corresponding to personal identification information indicated by the accessory information read from the database is smaller than the degree of matching obtained by said obtaining section.

15. A computer-readable storage medium which stores a computer program for causing a computer to carry out an authentication process, said computer program comprising:
an acquiring procedure causing the computer to acquire first and second feature information of a user;
an extracting procedure causing the computer to extract, from a database which registers first and second registered feature information together with accessory information related to predetermined users for which a degree of matching of the first registered feature information exceeds a predetermined value, specific accessory information corresponding to the first registered feature information having a degree of matching which is a maximum value with respect to the acquired first feature information; and
a confirming procedure causing the computer to confirm the user if a degree of matching of the acquired second feature information and the second registered feature information registered in the database in correspondence with the first registered feature information having the degree of matching which is the maximum value is greater than a degree of matching of the acquired second feature information and the second registered feature information corresponding to the specific accessory information.

16. The computer-readable storage medium as claimed in claim 15, wherein the first feature information and the second feature information are the same kind of feature information or mutually different kinds of feature information.
